(19) United States
(12) Patent Application Publication
(10) Pub. No.: US 2002/0147266 A1
(43) Pub. Date: Oct. 10, 2002

(54) Terpolymer-containing rubber mixtures

(76) Inventors: Adrian Rawlinson, Leverkusen (DE); Rudiger Engehausen, Dormagen (DE); Peter Wendling, Leverkusen (DE)

Correspondence Address: BAYER CORPORATION, PATENT DEPARTMENT, 100 BAYER ROAD, PITTSBURGH, PA, 15205, US

(21) Appl. No.: 10/056,862

(22) Filed: Jan. 25, 2002

(30) Foreign Application Priority Data
Jan. 31, 2001 (DE) 10104236.1

(51) Int. Cl. C08J 3/00

(52) U.S. Cl. 524/525; 524/565; 524/515

(57) ABSTRACT

The present invention provides rubber mixtures which contain at least one NSBR terpolymer and at least one polar synthetic plasticizer, a process for the preparation thereof and their use to produce rubber molded items of all kinds.

### FIELD OF THE INVENTION

The invention provides rubber mixtures which contain terpolymers based on an unsaturated olefinic nitrile, a vinylaromatic compound and a conjugated diene and also at least one polar synthetic plasticizer. Rubber mixtures according to the present invention may be used to prepare rubber molded items, in particular tires.

It is known that resistance to wet-skidding and abrasive strength can be improved by using terpolymers based on a conjugated diolefin, a vinylaromatic compound and an olefinically unsaturated nitrile. In this connection, reference is made, for example, to EP-A 537 640, U.S. Pat. Nos. 5,310,815, 5,225,479, DE-A 3 837 047 and EP-A 0 736 399. In addition, it is mentioned in these patents that the terpolymers disclosed therein may be admixed with other rubbers, wherein conventional rubber auxiliary substances may be added to these mixtures. Included among the very wide variety of rubber auxiliary substances, plasticizers are also described as auxiliary substances that may be used in a conventional manner.

### BACKGROUND OF THE INVENTION

The terpolymers and their mixtures with other rubbers described in the patents mentioned, however, still require some improvement with regard to dynamic properties such as the dynamic modulus at low temperatures and combination of the properties resistance to rolling, resistance to wet-skidding and abrasion.

It is know that carbon black or silica-containing tire treads based on non-polar rubbers or mixtures of the same which contain NSBR lead to an considerable increase in the tan δ value at 0° C., which indicates improved resistance to wet-skidding. Improved resistance to abrasion is also found, depending on the particular rubber mixture used. However, the use of NSBR in such mixtures also has negative effects, such as a greatly increased dynamic modulus at 0° C. and an elevated tan δ value at 60° C. A tire tread mixture with a high dynamic modulus at 0° C., however, has disadvantages at low temperatures with respect to ABS braking characteristics in the wet and also the driving characteristics. A high tan δ value at 60° C. also indicates a higher rolling resistance.

### SUMMARY OF THE INVENTION

Now, the object of the present invention is to provide rubber mixtures, based on terpolymers of the composition mentioned above, which have improved dynamic properties, such as the dynamic modulus at low temperatures, and also an improved combination of the properties rolling resistance, wet-skidding characteristics and resistance to abrasion.

This object is achieved by adding polar synthetic plasticizers to rubber mixtures which contain the terpolymers.

Therefore, the present invention provides rubber mixtures that contain

a) at least one terpolymer (NSBR) comprising an olefinically unsaturated nitrile, a vinylaromatic compound and a conjugated diene and

b) at least one polar synthetic plasticizer,

wherein component b) is present in amounts of 0.5 to 50 wt. %, with respect to the amount of terpolymer (a).

### DETAILED DESCRIPTION OF THE INVENTION

Rubber mixtures in which component b) is present in amounts of 5 to 40 wt. %, in particular 10 to 30 wt. %, each with respect to the amount of terpolymer (a), are preferred.

The terpolymer used as component a) in rubber mixtures according to the present invention is based, as mentioned above, on unsaturated olefinic nitrites, vinylaromatic compounds and conjugated dienes.

Suitable conjugated dienes are, in particular: 1,3-butadiene, 2,3-dimethyl-1,3-butadiene, 2-methyl-1,3-butadiene, 2-ethyl-1,3-butadiene, 1,3-pentadiene, 2-methyl-1,3-pentadiene, 1,3-hexadiene, 2-phenyl-1,3-butadiene, 3,4-dimethyl-1,3-hexadiene, 1,3-heptadiene, 1,3-octadiene, 4,5-diethyl-1,3-octadiene, 3-methyl-1,3-pentadiene, 4-methyl-1,3-pentadiene or mixtures of the dienes mentioned. The following are preferably used as conjugated dienes: 1,3-butadiene and 2-methyl-1,3-butadiene, in particular 1,3-butadiene.

Vinylaromatic compounds which may be mentioned are those which contain 8 to 16 carbon atoms in the molecule such as styrene, α-methylstyrene, 2-methylstyrene, 3-methylstyrene, 4-methylstyrene, 4-cyclohexylstyrene, 4-p-toluenestyrene, p-chlorostyrene, p-bromostyrene, 4-tert-butylstyrene, 1-vinylnaphthalene, 2-vinylnaphthalene or mixtures of the same, wherein styrene is preferred.

Olefinically unsaturated nitrites, which may be used to build up the terpolymer are acrylonitrile, methacrylonitrile, ethylacrylonitrile, crotononitrile, 2-pentenonitrile or mixtures of the same, wherein acrylonitrile is preferred.

Terpolymers to be used according to the present invention contain the conjugated dienes in amounts of about 40 to 89 wt. %, the vinylaromatic compounds in amounts of about 10 to 40 wt. % and the olefinically unsaturated nitrites in amounts of about 1 to 50 wt. %, wherein the amounts of the individual components add up to 100 wt. %.

The conjugated dienes are preferably used in amounts of 40 to 80 wt. %, the vinylaromatic compounds in amounts of 10 to 35 wt. % and the olefinically unsaturated nitrites in amounts of 10 to 40 wt. %.

Depending on the amounts of the structural components being used, the glass transition temperature of terpolymers used according to the present invention is about −60 to 0° C., preferably −45 to −15° C.

NSBR terpolymers used according to the present invention are known, for example from the patent documents mentioned above, as well as the method of preparation.

As mentioned above, it is of particular importance for the physical properties of rubber mixtures according to the present invention, and the vulcanizates and molded items produced therefrom, that polar synthetic plasticizers are added to the rubber mixtures. Suitable polar synthetic plasticizers are those which contain e.g. ester or ether groups in the molecule, for example phthalates such as dibutyl phthalate (DBP), dioctyl phthalate (DOP), diisononyl phthalate (DINP), diisodecyl phthalate (DIDP), diisotridecyl phthalate (DTDP), diundecyl phthalate (DUP), sebacates such as dioctyl sebacate (DOS), dibutyl sebacate (DBS), adipates such as dioctyl adipate (DOA), diisodecyl adipate (DIDA), diisononyl adipate (DINA), di-(butoxyethoxyethyl) adipate, phosphates such as tricresyl phosphate (TCP), trixylyl phosphate (TXP), trioctyl phosphate (TOP), diphenylcresyl phosphate, diphenyloctyl phosphate, trichloroethyl phosphates, stearates such as butyl stearate, azelates such as dioctyl azelate, oleates such as dibutyl oleate, trimellitates such as trioctyl mellitate, tri-linear-C₇-C₉ trimellitates, glycolates such as dibutylmethylene-bis-thioglycolate, di-2-ethylhexyl-thiodigycolate ester, nylonates such as dioctyl nylonate, diisodecyl nylonate, phenylalkyl sulfonates, butyl-carbitol-formal, and mixed esters of adipic, glutaric and succinic acids.

In addition, suitable polar plasticizers are: chlorinated paraffins with a chlorine content of 40 to 70 wt. % and also plasticizers based on epoxy esters, based on polyesters and polyethers, based on ether-thioethers and also those based on phenolsulfonates.

The polar synthetic plasticizers may be used either separately or as a mixture with each other. The most beneficial mixture is governed by the particular ultimate purpose of the rubber mixtures according to the present invention.

Plasticizers based on phthalic acid, sebacic acid and adipic acid, of the type mentioned above, are preferred.

Obviously, rubber mixtures according to the present invention may contain, in addition to the polar synthetic plasticizers, known fillers and rubber auxiliary substances such as pigments, zinc oxide, stearic acid, vulcanization accelerators, vulcanization agents, for example, those based on sulfur and peroxide, stabilizers, antioxidants, resins, oils, waxes and inhibitors.

Suitable fillers for rubber mixtures according to the present invention are either the well-known carbon blacks and silicas, or else silicates, titanium dioxide, chalk or clay or mixtures of the same. Carbon black and silica are preferably used as fillers.

When using silicas in the rubber mixtures, so-called filler activators such as bis-3-(triethoxysilylpropyl) tetrasulfite, may also be used in a well-known manner.

The additives and auxiliary substances mentioned are also known to a person skilled in the art and are described, inter alia, in Kautschuk-Technology by Werner Hoffmann, post-doctoral thesis for the faculty of engineering, T H Aachen, 1975; Handbuch für die Gummiindustrie from Bayer A G, Leverkusen, Hoffmann, W.: Kautschuktechnology Stuttgart (Genter 1980) and in Helle Füllstoffe in Polymeren, Gummi Faser Kunststoffe 42 (1989) no. 11.

The fillers and rubber auxiliary substances mentioned are used in conventional amounts. The most beneficial amounts in any particular instance are governed, inter alia, by the intended ultimate purpose of the rubber mixtures and may be readily determined by appropriate preliminary trials.

Obviously, natural (NR) and synthetic rubbers may also be added to rubber mixtures according to the present invention, such as, for example, polybutadiene (BR), styrene/butadiene copolymers (SBR), polyisoprene rubbers (IR), isoprene/butadiene rubbers, isoprene/butadiene/styrene rubbers, ethylene/propylene rubbers. Polybutadiene, styrene/butadiene copolymers and natural rubbers are preferably used. Oils based on aromatic compounds, naphthenes or paraffins may obviously also be added to the additional rubbers mentioned for use in rubber mixtures according to the present invention, as is conventional.

The additionally used rubbers are prepared in a conventional manner by radical emulsion polymerization, radical solution polymerization, anionic or cationic polymerization or by Ziegler-Natta polymerization in a well-known manner.

The amount of added additional rubber may vary over a wide range and is governed in particular by the subsequent intended purpose of rubber mixtures according to the present invention based on NSBR and synthetic plasticizers.

In general, the additional rubbers mentioned are used in amounts of 1 to 99, preferably 10 to 90, more preferably 20 to 80 wt. %, with respect to the entire amount of rubber.

Rubber mixtures according to the present invention may be prepared by intensive mixing of the individual components with each other in suitable mixing units such as rollers or compounders.

Rubber mixtures according to the present invention are preferably prepared by mixing component a), i.e. the terpolymer (NSBR) in latex form with the polar synthetic plasticizer(s) (component b)) and working up the mixture obtained thereby in an appropriate manner by coagulating and then drying.

Addition of the plasticizer to the NSBR latex may be performed by simple mixing of the two components. It is also possible to add the plasticizer in the form of an aqueous emulsion to the latex, wherein conventional, known emulsifiers are added. It is then possible to use those emulsifiers which were also used during preparation of the latex. Obviously, the use of other emulsifiers is also possible.

The NSBR latex/plasticizer mixture may be prepared at room temperature or at elevated temperature, the latter in particular when the plasticizer being added has a high viscosity.

Coagulation of the latex/plasticizer mixture may be performed by known and conventional methods. Examples of these are the introduction of mechanical energy, wherein coagulation is achieved by shearing, the use of a purely thermal process or by the addition of precipitating agents such as alkali metal, alkaline earth metal or aluminium salts or inorganic or organic acids, wherein the use of precipitation auxiliary agents such as gelatine and/or polyelectrolytes is also possible. The use of precipitating agents of the type mentioned is preferred.

The coagulated mixture may be subjected to one or more wash steps, in a known manner, wherein preliminary dewatering in equipment suitable for this purpose, for example in a dewatering screw, is possible before drying the coagulated mixture.

The fillers and rubber auxiliary substances described above may then be admixed with the coagulated and dried rubber mixtures obtained, in a known manner.

Rubber mixtures according to the present invention may be vulcanized in a conventional way, wherein the most expedient vulcanization process to use is governed by the particular ultimate purpose of the rubber mixtures.

Rubber mixtures according to the present invention may be used to produce vulcanizates of all kinds, in particular to produce tire components and to produce industrial rubber goods such as belts, seals and hoses.

Use of rubber mixtures according to the present invention in tire structures, in particular for tire treads, is preferred.

In the following examples, the properties of rubber mixtures according to the present invention of comparison rubber mixtures and of the resulting vulcanizates were measured as follows:

(1) The polymer composition was measured by means of IR spectroscopy.

(2) The Mooney viscosity of the rubber was determined according to DIN 53523.

(3) The tensile strength of the vulcanizates was determined according to DIN 53504.

(4) The extension at break of the vulcanizates was determined according to DIN 53504.

(5) The modulus of the vulcanizates at 100 and 300% extension was determined according to DIN 53504.

(6) The hardness of the vulcanizates at 70° C. was determined according to DIN 53505.

(7) Abrasion of the vulcanizates was determined according to DIN 53516.

(8) Tan δ of the vulcanizates was determined according to DIN 53513.

### EXAMPLES

The following components were used for comparison rubber mixtures 1 and 2 and also for rubber mixtures 1, 2 and 3 according to the present invention:

NSBR (rubber prepared by emulsion polymerization, 58.5% butadiene, 20.3% styrene and 21.1% acrylonitrile, Mooney viscosity 49), Krylene® 1500 (emulsion SBR, 23.5% styrene, manufacturer Bayer Elastomers),

NR (natural rubber TSR 5, cis-1,3-polyisoprene),

Renopal® 450 (aromatic mineral oil/plasticizer, manufacturer Fuchs Chemie),

Corax® N339 (carbon black, manufacturer Degussa Hüls AG),

Stearic acid,

ZnO (zinc oxide),

Sulfur,

Vulkanox® 4010 (N-isopropyl-N′-phenyl-p-diphenylenediamine, manufacturer Bayer AG),

Vulkanox® 4020 (N-(1,3-dimethylbutyl)-N′phenyl-p-phenylenediamine, manufacturer Bayer AG),

Vulkacit® D (diphenylguanidine, manufacturer Bayer AG),

Vulkacit® CZ/C (N-cyclohexyl-2-benzothiazyl-sulfenamide, manufacturer Bayer AG),

DOP: Vestinol AH, (dioctyl phthalate, Hüls AG),

DOS: Edenol 888, (dioctyl sebacate, Henkel KGaA),

The individual proportions by weight of the components are listed in Tables 1 and 2.

The components were mixed in a compounder (Werner & Pfleiderer GK 1.5) at 50 rpm. The compounding temperature was 60° C. The vulcanization accelerator was admixed on a roller.

The results of the tests are given in Tables 1 and 2.

TABLE 1

| | | Example 1 | Example 2 | Comp. Example 1 |
|---|---|---|---|---|
| Krylene ® 1500 | | 80 | 80 | 80 |
| NSBR 20% ACN | | 20 | 20 | 20 |
| Corax ® N339 | | 50 | 50 | 50 |
| Aromatic oil | | 15 | 15 | 30 |
| DOP | | 15 | 0 | 0 |
| DOS | | 0 | 15 | 0 |
| Stearic acid | | 2 | 2 | 2 |
| Zinc oxide | | 3 | 3 | 3 |
| Vulkanox ® 4010 | | 1 | 1 | 1 |
| Vulkanox ® 4020 | | 1 | 1 | 1 |
| Sulfur | | 2 | 2 | 2 |
| Vulkacit ® CZ/C | | 1.5 | 1.5 | 1.5 |
| Vulkacit ® D | | 0.2 | 0.2 | 0.2 |
| Tensile strength (MPa) | | 21.1 | 20.6 | 21.1 |
| Extension at break (%) | | 635 | 625 | 640 |
| Modulus 100% (MPa) | | 1.5 | 1.5 | 1.6 |
| Modulus 300% (MPa) | | 6.6 | 6.7 | 6.5 |
| Hardness 23° C. (Shore A) | | 57 | 55 | 57 |
| Hardness 70° C. (Shore A) | | 51 | 51 | 51 |
| DIN abrasion 60 (mm³) | | 130 | 115 | 140 |
| tan δ | 0° C. | 0.477 | 0.496 | 0.463 |
| | 23° C. | 0.278 | 0.273 | 0.339 |
| | 60° C. | 0.193 | 0.187 | 0.216 |
| E* | 0° C. | 19.489 | 16.723 | 62.777 |
| | 23° C. | 8.573 | 7.376 | 10.555 |
| | 60° C. | 5.424 | 5.438 | 5.727 |
| E′ | 0° C. | 17.589 | 14.983 | 56.973 |
| | 23° C. | 8.261 | 7.115 | 9.995 |
| | 60° C. | 5.326 | 5.346 | 5.598 |
| E″ | 0° C. | 8.394 | 7.429 | 26.365 |
| | 23° C. | 2.294 | 1.945 | 3.391 |
| | 60° C. | 1.025 | 1 | 1.209 |

The results in Table 1 show that rubber mixtures according to invention exhibit advantages over those from the prior art in properties such as much lower dynamic moduli, higher tan δ values at 0° C. (better resistance to wet-skidding), lower tan δ values at 60° C. (lower resistance to rolling) and lower DIN abrasion (less wear), while they have comparable mechanical properties.

TABLE 2

| | | Example 3 | Comp. example 2 |
|---|---|---|---|
| NR (masticated) | | 80 | 80 |
| NSBR 20% ACN | | 20 | 20 |
| Corax ® N339 | | 50 | 50 |
| Aromatic oil | | 15 | 30 |
| DOP | | 15 | 0 |
| Stearic acid | | 2 | 2 |
| Zinc oxide | | 3 | 3 |
| Vulkanox ® 4010 | | 1 | 1 |
| Vulkanox ® 4020 | | 1 | 1 |
| Sulfur | | 2 | 2 |
| Vulkacit ® CZ/C | | 1.5 | 1.5 |
| Vulkacit ® D | | 0.2 | 0.2 |
| Tensile strength (MPa) | | 23.8 | 23.5 |
| Extension at break (%) | | 615 | 610 |
| Modulus 100% (MPa) | | 1.8 | 1.8 |
| Modulus 300% (MPa) | | 7.7 | 7.1 |
| Hardness 23° C. (Shore A) | | 59 | 59 |
| Hardness 70° C. (Shore A) | | 51 | 51 |
| DIN abrasion 60 (mm³) | | 130 | 130 |
| tan δ | 0° C. | 0.424 | 0.452 |
| | 23° C. | 0.243 | 0.3 |
| | 60° C. | 0.155 | 0.178 |
| E* | 0° C. | 13.039 | 37.024 |
| | 23° C. | 6.777 | 7.847 |
| | 60° C. | 4.808 | 4.911 |
| E′ | 0° C. | 12.006 | 33.738 |
| | 23° C. | 6.586 | 7.515 |
| | 60° C. | 4.751 | 4.835 |
| E″ | 0° C. | 5.088 | 15.248 |
| | 23° C. | 1.599 | 2.257 |
| | 60° C. | 0.738 | 0.86 |

The results in table 2 show that rubber mixtures according to the present invention exhibit advantages over those from the prior art in properties such as much lower dynamic moduli and lower tan δ values at 60° C. (lower resistance to rolling) while they have comparable mechanical properties.

### Example 4

(Preparing Rubber Mixtures According to the Present Invention by the Latex Process)

Preparing the Terpolymers

1631.3 g styrene, 7.31 g tert.-dodecylmercaptan, 900 g acrylonitrile and a solution consisting of 7537.4 g fully deionised water, 197.68 g disproportionated resin acid (sodium salt, 70% strength), 2175 g partially hydrogenated tallow fatty acid (potassium salt, 9% strength), 14.06 g potassium hydroxide (85% strength), 32.06 g condensed naphthalenesulfonic acid (Na salt) and 14.63 g potassium chloride were initially introduced into an evacuated stirrable 20 I steel reactor. All the components had previously been flushed out with nitrogen. Then 4162.50 g butadiene were added and the emulsion was brought to a constant temperature of 10° C. with stirring. Polymerization was initiated by adding 1.52 g p-menthane hydroperoxide (50% strength) and a solution consisting of 167.91 g fully deionised water, 1.69 g EDTA, 1.35 g iron(II) sulfate heptahydrate, 3.46 g sodium formaldehydesulfoxylate and 5.23 g sodium phosphate dodecahydrate and allowed to proceed with stirring at 10° C.

Polymerization was terminated at a conversion of 80.2% by adding 22.5 g diethylhydroxylamine (25% strength) and 1.13 g sodium dithionite. 13.50 g Vulkanox® BKF (2,2′-methylene-bis-(4-methyl-6-tert.-butylphenol), product from Bayer AG, Leverkusen), added in the form of a 46% strength dispersion (29.35 g), were added to the latex. Unreacted butadiene was degassed and unreacted monomers were removed from the latex with steam. A small sample was coagulated and the polymer was dried. The polymer had a Mooney viscosity (ML 1+4) of 151. The polymer composition was determined by IR spectroscopy, giving 57.4% butadiene, 22.7% styrene and 19.9% acrylonitrile. The gel content in toluene was 2.2%.

Preparing the Latex-plasticizer Mixture

275 g DOP (25 phr) were added to 3200 g latex, corresponding to 1100 g polymer. For this purpose, the DOP was emulsified in an aqueous solution consisting of 340.93 g water, 0.41 g polynaphthalenesulfonic acid, 59.4 g disproportionated resin acid (sodium salt, 10% strength) and 11.62 g partially hydrogenated tallow fatty acid (potassium salt, 9% strength) with stirring. The latex and DOP emulsion were heated to 60° C. and mixed with stirring. Stirring was continued for 30 min.

Coagulating the Latex-plasticizer Mixture

10 kg of fully deionised water, heated to 65° C., 825 g sodium chloride and 2.25 g polyamine (Superfloc® C567) were initially introduced into a stirred tank. The latex-plasticizer mixture was added at 65° C. with stirring. The pH of the precipitation serum was adjusted to and maintained at 4 by adding 10% strength sulfuric acid.

The precipitation serum was clear. The DOP-extended rubber was filtered off and washed with fully deionised water, heated to 65°C., for 15 min with stirring. The water: rubber ratio was 10:1. The moist, DOP-extended rubber was dried at 70° C. in a vacuum drying cabinet. The Mooney viscosity (ML 1+4) was 66 MU.

Examples 5 to 7 were prepared in the same way. Table 3 gives a summary of the masterbatches prepared according to the present invention.

TABLE 3

| Plasticizer | Example 4 | Example 5 | Example 6 | Example 7 |
|---|---|---|---|---|
| DOP | 25 phr | | | |
| DOP | | 50 phr | | |
| DOS | | | 37.5 phr | |
| TKP | | | | 37.5 phr |
| ML 1 + 4 of the | 66 | 34 | 47 | 100 |
| master batches | | | | |

Testing Examples and Comparison Examples

The following components were used for the comparison rubber mixtures and rubber mixtures according to the present invention. Masterbatches from examples 6 to 9

NSBR (rubber prepared by emulsion polymerization, 58.5% butadiene, 20.3% styrene and 21.1% acrylonitrile, Mooney viscosity 49),

SBR 1500 (Krylene® 1500, emulsion SBR, 23.5% styrene, manufacturer Bayer Elastomers),

Renopal® 450 (aromatic mineral oil/plasticizer, manufacturer Fuchs Chemie),

Corax® N339 (carbon black, manufacturer Degussa Hüls AG),

Stearic acid,

ZnO (zinc oxide),

Sulfur,

Vulkanox® 4010 (N-isopropyl-N′-phenyl-p-diphenylenediamine, manufacturer Bayer AG),

Vulkanox®4020 (N-(1,3-dimethylbutyl)-N′phenyl-p-phenylenediamine, manufacturer Bayer AG),

Vulkacit® D (diphenylguanidine, manufacturer Bayer AG),

Vulkacit® CZ/C (N-cyclohexyl-2-benzothiazyl-sulfenamide, manufacturer Bayer AG),

DOP: Vestinol AH, (dioctyl phthalate, Hüls AG),

DOS: Edenol 888, (dioctyl sebacate, Henkel KGaA),

TKP: Disflamoll TKP (tricresyl phosphate, Bayer AG).

The individual proportions by weight of the components are given in tables 4 and 6.

The components were mixed in a compounder (Werner & Pfleiderer GK 1.5) at 50 rpm. The compounder temperature was 60° C. The vulcanization accelerators were admixed later on a roller.

The results of the tests are given in tables 5 and 7.

TABLE 4

| | Example 4 | Example 5 | |
|---|---|---|---|
| | DOP-25 | DOP-50 | |
| | 5 DOP | 10 DOP | Comp. example 1 |
| SBR 1500 | 80 | 80 | 80 |
| NSBR 1 | 0 | 0 | 20 |
| Masterbatch with 25 phr DOP | 25 | 0 | 0 |
| Masterbatch with 50 phr DOP | 0 | 30 | 0 |
| Arom. mineral oil | 25 | 20 | 30 |
| DOP | 0 | 0 | 0 |
| Carbon black N339 | 50 | 50 | 50 |
| Stearic acid | 2 | 2 | 2 |
| Zinc oxide | 3 | 3 | 3 |
| Vulkanox 4010 NA | 1 | 1 | 1 |
| Vulkanox 4020 | 1 | 1 | 1 |
| Sulfur | 2 | 2 | 2 |
| Vulkacit CZ | 1.5 | 1.5 | 1.5 |
| Vulkacit D | 0.2 | 0.2 | 0.2 |
| Ps. by wt. of synthetic | 5 | 10 | 0 |
| plasticizer in the mixture, with | | | |
| respect to rubber | | | |

TABLE 5

| | | | | Comp. |
|---|---|---|---|---|
| Vulcanizate properties | | Example 4 | Example 5 | example 1 |
| Tensile strength | (MPa) | 22.6 | 23.6 | 21.1 |
| Extension at break | (%) | 622 | 620 | 640 |
| Modulus 100% | (MPa) | 1.67 | 1.66 | 1.6 |
| Modulus 300% | (MPa) | 7.32 | 7.99 | 6.5 |
| Hardness 23° C. | (Shore A) | 58 | 57 | 57 |
| Hardness 70° C. | (Shore A) | 51 | 51 | 51 |
| DIN abrasion 60 | (mm³) | 133 | 104 | 140 |
| tan δ | 0° C. | 0.567 | 0.556 | 0.463 |
| | 23° C. | 0.299 | 0.291 | 0.339 |
| | 60° C. | 0.190 | 0.187 | 0.216 |
| E* | 0° C. | 30.770 | 22.060 | 62.777 |
| | 23° C. | 8.096 | 8.149 | 10.555 |
| | 60° C. | 4.934 | 5.121 | 5.2727 |
| E′ | 0° C. | 26.762 | 19.283 | 59.973 |
| | 23° C. | 7.757 | 7.823 | 9.995 |
| | 60° C. | 4.847 | 5.034 | 5.598 |
| E″ | 0° C. | 15.185 | 10.716 | 26.635 |
| | 23° C. | 2.320 | 2.279 | 3.391 |
| | 60° C. | 0.920 | 0.941 | 1.209 |

The results in table 5 show that masterbatches according to the present invention, as compared with the prior art (comparison example 1), exhibit advantages such as much lower dynamic moduli, higher tan δ values at 0° C. (better resistance to wet-skidding), lower tan δ value at 60° C. (lower resistance to rolling) and lower DIN abrasion (less wear), with sometimes improved tensile strengths. This also applies at low concentrations of polar plasticizers.

TABLE 6

| | Example 6 | Example 7 | |
|---|---|---|---|
| | DOS-37.5 | TKP-37.5 | |
| | 7.5 DOS | 7.5 TKP | Comp. example 1 |
| SBR 1500 | 80 | 80 | 80 |
| NSBR 1 | 0 | 0 | 20 |
| Masterbatch with 37.5 phr | 27.5 | 0 | 0 |
| DOS | | | |
| Masterbatch with 37.5 phr | 0 | 27.5 | 0 |
| TPK | | | |
| Arom. Mineral oil | 22.5 | 22.5 | 30 |
| DOP | 0 | 0 | 0 |
| Carbon black N339 | 50 | 50 | 50 |
| Stearic acid | 2 | 2 | 2 |
| Zinc oxide | 3 | 3 | 3 |
| Vulkanox 4010 NA | 1 | 1 | 1 |
| Vulkanox 4020 | 1 | 1 | 1 |
| Sulfur | 2 | 2 | 2 |
| Vulkacit CZ | 1.5 | 1.5 | 1.5 |
| Vulkacit D | 0.2 | 0.2 | 0.2 |
| Pts. by wt. of synthetic | 7.5 | 7.5 | 0 |
| plasticizer in the mixture, | | | |
| with respect to rubber | | | |

TABLE 7

| Vulcanizate properties | | Example 6 | Example 7 | Comp. example 1 |
|---|---|---|---|---|
| Tensile strength | | 21.8 | 23.1 | 21.1 |
| Extension at break | | 627 | 656 | 640 |
| Modulus 100% | | 1.55 | 1.59 | 1.6 |
| Modulus 300% | | 7 | 6.9 | 6.5 |
| Hardness 23° C. | | 56 | 56 | 57 |
| Hardness 70° C. | | 50 | 50 | 51 |
| DIN abrasion 60 | | 125 | 135 | 140 |
| tan δ | 0° C. | 0.552 | 0.584 | 0.463 |
| | 23° C. | 0.290 | 0.304 | 0.339 |
| | 60° C. | 0.185 | 0.190 | 0.216 |
| E* | 0° C. | 23.034 | 28.278 | 62.777 |
| | 23° C. | 7.622 | 7.998 | 10.555 |
| | 60° C. | 4.909 | 4.806 | 5.2727 |
| E′ | 0° C. | 20.168 | 24.417 | 59.973 |
| | 23° C. | 7.321 | 7.651 | 9.995 |
| | 60° C. | 4.827 | 4.722 | 5.598 |
| E″ | 0° C. | 11.127 | 14.262 | 26.635 |
| | 23° C. | 2.121 | 2.329 | 3.391 |
| | 60° C. | 0.894 | 0.897 | 1.209 |

The results in table 7 show that masterbatches according to the present invention (examples 6 and 7), containing different polar plasticizers from masterbatches according to the present invention in examples 4 and 5 are superior to the prior art (comparison example 1).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Rubber mixtures comprising
a) at least one terpolymer (NSBR) which comprises an olefinically unsaturated nitrile, a vinylaromatic compound and a conjugated diene; and
b) at least one polar synthetic plasticizer,
wherein component b) is present in an amount of 0.5 to 50 wt. %, with respect to the amount of terpolymer (a).

2. Rubber mixtures according to claim 1, wherein said rubber mixtures comprise at least one other synthetic or natural rubber or mixtures of the same, wherein the amount of added rubber is 1 to 99 wt. %, with respect to the total amount of rubber.

3. Vulcanizates comprising rubber mixtures, which contain
a) at least one terpolymer (NSBR) comprising an olefinically unsaturated nitrile, a vinylaromatic compound and a conjugated diene; and
b) at least one polar synthetic plasticizer,
wherein component b) is present in an amount of 0.5 to 50 wt. %, with respect to the amount of terpolymer (a).

4. Vulcanizates comprising rubber mixtures, which contain
a) at least one terpolymer (NSBR) comprising an olefinically unsaturated nitrile, a vinylaromatic compound and a conjugated diene; and
b) at least one polar synthetic plasticizer, and
c) at least one other synthetic or natural rubber or mixtures of the same,
wherein component b) is present in an amount of 0.5 to 50 wt. %, with respect to the amount of terpolymer (a). and wherein component c) is present in an amount of 1 to 99 wt. %, with respect to the total amount of rubber.

5. The vulcanizates according to claim 3 and 4, wherein said vulcanizates are tire components or industrial rubber goods.

6. A process for producing rubber mixtures having
a) at least one terpolymer (NSBR) which comprises an olefinically unsaturated nitrile, a vinylaromatic compound and a conjugated diene; and
b) at least one polar synthetic plasticizer,
wherein component b) is present in an amount of 0.5 to 50 wt. %, with respect to the amount of terpolymer (a), comprising the step of mixing NSBR terpolymers in latex form with polar synthetic plasticizers to obtain a mixture, mutually coagulating the mixture and then drying the mixture.
